(19) United States
(12) Patent Application Publication
(10) Pub. No.: US 2005/0179807 A1
(43) Pub. Date: Aug. 18, 2005

(54) Multiple-sensor camera

(76) Inventor: William Lin, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/816,607

(22) Filed: Apr. 1, 2004

(30) Foreign Application Priority Data
Feb. 15, 2004 (CN) 200410005711.4

(51) Int. Cl. H04N 5/225; H04N 1/04; H04N 9/09; H04N 9/097; G02B 26/08

(52) U.S. Cl. 348/344; 348/262; 359/196

(57) ABSTRACT

The disclosure has described a multiple-sensor camera. In one embodiment, the camera includes a single lens, a plurality of image sensors, each of the plurality of image sensors having distinct characteristics, and an optical device positioned between the lens and the plurality of image sensors to direct light rays from the lens to one of the plurality of image sensors.

The present application claims foreign priority benefit of Chinese Application No. 200410005711.4, filed Feb. 15, 2004, the contents of which is hereby incorporated by reference in its entirety.

### FIELD OF INVENTION

The present invention relates to cameras, and more particularly, to using two or more image sensors with a single lens to produce images with different effects.

### BACKGROUND

A contemporary camera typically includes a lens and an image sensor. Light rays entering through the lens are generally directed to the image sensor. In response to the light rays, the image sensors output electronic signals to an electronic system, which may record, display or compress the electronic signals from the image sensor. Currently, there are various types of image sensors, such as the charge-coupled device (CCD) sensors and the complementary metal oxide semiconductor (CMOS) sensors. Either a CCD sensor or a CMOS sensor may be used in the contemporary camera. Furthermore, each kind of image sensors can be divided into two categories, namely, color image sensors and black-and-white image sensors.

Many of the existing cameras have only a single image sensor. Although color images are preferred in many applications, one issue of the color image sensors is that the color image sensors generally have lower optical sensitivity than the black-and-white image sensors. The color image sensors may generate sharp images during daytime or in a well-lit environment. But at night or in a dark environment, the color image sensors cannot generate images as sharp as those generated by the black-and-white image sensors.

Furthermore, the existing CCD color sensors typically operate with an infrared filter in order to generate images with real-life color. Since the infrared filter blocks the infrared light from the CCD color sensors, it is ineffective to supplement the natural light with infrared light in a dark environment when using cameras having the CCD color sensors. Moreover, even if the infrared filter may be optionally removed depending on the lighting condition, such as implemented in one of the cameras provided by Sony Corporation, such implementation still does not solve the problem of the lower sensitivity of the CCD color sensors.

Another potential solution to the above problem is to provide both a first camera having a black-and-white image sensor and a second camera having a color image sensor. Hence, one may choose one of the cameras depending on the lighting condition. However, the cost of such a setup would be too high to provide much practical advantage.

Another type of existing cameras includes three image sensors, each of which is designated to detect a distinct primary color (e.g., red, green, or blue). Each of the color image sensors generates signals of the corresponding individual primary color. The real color of a single pixel is determined using the signals from all three image sensors. In other words, the three color image sensors are used together to generate a single image. These three color image sensors are not intended to be used individually.

### SUMMARY

A multiple-sensor camera is disclosed. In one embodiment, the camera includes a single lens, a plurality of image sensors, each of the plurality of image sensors having distinct characteristics, and an optical device positioned between the lens and the plurality of image sensors to direct light rays from the lens to one of the plurality of image sensors.

Other features of the present invention will be apparent from the accompanying drawings and from the detailed description that follows.

### BRIEF DESCRIPTION OF THE DRAWINGS

The present invention will be understood more fully from the detailed description that follows and from the accompanying drawings, which however, should not be taken to limit the appended claims to the specific embodiments shown, but are for explanation and understanding only.

FIGS. 1-3 illustrate one embodiment of a multiple-sensor camera.

FIG. 4 illustrates an alternate embodiment of a multiple-sensor camera.

FIG. 5 shows one embodiment of a multiple-sensor camera.

FIGS. 6-8 show another embodiment of a multiple-sensor camera.

FIG. 9 illustrates one embodiment of a multiple-sensor camera.

FIG. 10 shows one embodiment of a multiple-sensor camera.

FIG. 11 shows one embodiment of a multiple-sensor camera.

FIG. 12 shows one embodiment of a multiple-sensor camera.

FIGS. 13-16 show one embodiment of a multiple-sensor camera.

FIG. 17 shows one embodiment of a multiple-sensor camera.

FIG. 18 shows one embodiment of a multiple-sensor camera.

FIG. 19 shows one embodiment of a multiple-sensor camera.

FIG. 20 shows one embodiment of a multiple-sensor camera.

### DETAILED DESCRIPTION

In the following description, numerous specific details are set forth. However, it is understood that embodiments of the invention may be practiced without these specific details. In other instances, well-known components, structures, and techniques have not been shown in detail in order not to obscure the understanding of this description.

In one embodiment, a camera includes multiple image sensors and a single lens installed within a housing. The image sensors include different types of image sensors. For instance, the image sensors may include a color image sensor and a black-and-white image sensor. Furthermore, the image sensors may include one or more CCD sensors and/or CMOS sensors. The light rays from an image may be directed to either the color CCD image sensor or the black-and-white CCD image sensor using an optical device inside the camera. For example, when taking pictures during daytime or in a well-lit environment, the optical device may direct the light rays onto the color CCD sensor in order to generate a color image. When taking pictures at night or in a dark environment, the optical device may direct the light rays onto the black-and-white CCD sensor in order to generate a sharper black-and-white image because the black-and-white CCD sensor is typically more sensitive than the color CCD sensor.

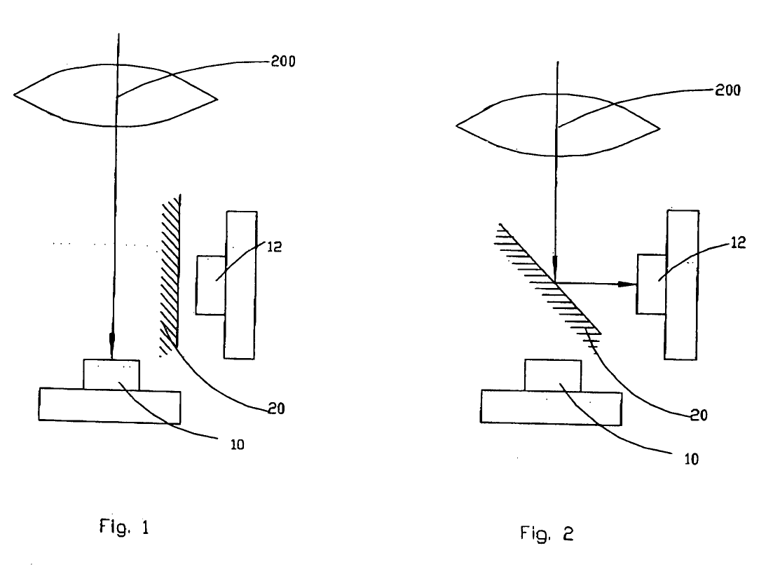

FIGS. 1-3 illustrate one embodiment of a camera. The camera includes a first image sensor 10, a second image sensor 12. For example, the first image sensor 10 may be a color CCD sensor and the second image sensor 12 may be a black-and-white CCD sensor. The camera further includes a lens 200 and an optical device 20. In one embodiment, the optical device 20 can be adjusted or moved. For example, the optical device 20 may be moved within the camera by a mechanical and/or electrical controller. Furthermore, the optical device 20 may be operable to reflect light. In one embodiment, the optical device 20 includes a mirror. The optical device 20 is installed in between the lens 200 and the first and second image sensors 10 and 12.

To take pictures during daytime or in a well-lit environment, the optical device 20 may be moved away from the path of the light ray such that the light ray is not blocked from the first image sensor 10. For example, the light ray directly falls onto the first image sensor 10 in the configuration shown in FIG. 1. In one embodiment, the first image sensor 10 is a color CCD sensor, and thus, the camera operates as a color camera in this configuration to generate color images.

Referring to FIG. 2, to take pictures at night or in a dark environment, the optical device 20 may be moved by a predetermined angle such that the optical device 20 reflects the light ray onto the second image sensor 12 and blocks off the light ray from the first image sensor 10. The second image sensor 12 may include a black-and-white CCD sensor. The black-and-white CCD sensor is more sensitive than the color CCD sensor, and thus, is able to produce sharper images than the color CCD sensor in the darker environment. Therefore, the camera operates as a black-and-white camera in this configuration.

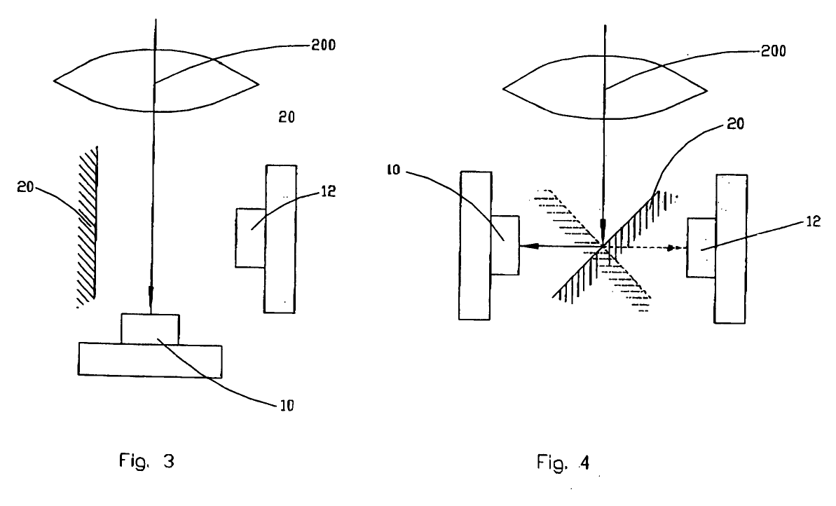

FIG. 3 illustrates an alternate position at which the optical device 20 may be placed to allow the first image sensor 10 to receive the light ray from the lens 200.

FIG. 4 illustrates an alternate embodiment of the camera. The camera includes an optical device 20, a first and a second image sensors 10 and 12, and a lens 200. Referring to FIG. 4, the optical device 20 having a reflective surface is positioned between the first and second image sensors 10 and 12. The optical device 20 may be rotated by a first predetermined angle to reflect the light ray onto the first image sensor 10. Likewise, the optical device 20 may be rotated by a second predetermined angle to reflect the light ray onto the second image sensor 12. In one embodiment, one of the image sensors 10 and 12 is a color sensor and the other one is a black-and-white sensor. By moving the optical device 20 to direct the light ray onto only one of the image sensors 10 and 12, a user may choose to operate the camera as a color camera or a black-and-white camera.

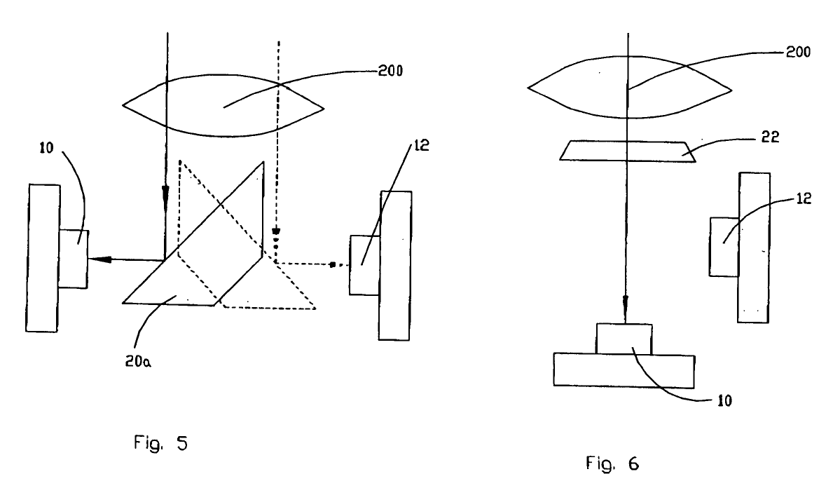

FIG. 5 illustrates one embodiment of the camera. The camera includes a lens 200, a first and a second image sensors 10 and 12, and a prism 20a. The prism 20a is positioned between the image sensors 10 and 12. By moving the prism 20a, some or all of the light rays through the lens 200 may be reflected to one of the image sensors 10 and 12. For example, placing the prism at the position indicated by the solid line reflects the light ray onto the first image sensor 10. Likewise, placing the prism at the position indicated by the dotted line reflects the light ray onto the second image sensor 12.

In one embodiment, the image sensors 10 and 12 may include a color CMOS sensor and a black-and-white CMOS sensor. Alternatively, the image sensors 10 and 12 may include a color CCD sensor and a black-and-white CCD sensor. One should appreciate that the image sensors 10 and 12 may include various combinations of different types of image sensors in order to produce sharp images under a wide range of conditions.

FIGS. 6-8 illustrate another embodiment of a camera according to the present invention. The camera includes a lens 200, a first and a second image sensors 10 and 12, and an optical device 22. The optical device 22 can reflect a predetermined portion of the light ray from the lens 200 and refract another predetermined portion of the light ray. In one embodiment, the optical device 22 includes an infrared filter with a reflective surface.

Referring to FIG. 6, the optical device 22 is placed underneath the lens 200 during daytime or in a well-lit environment. The light ray from the lens 200 passes through the optical device 22 and falls onto the first image sensor 10. The first image sensor 10 may be a color CCD sensor. In this situation, the camera may operate as a color camera to generate color images.

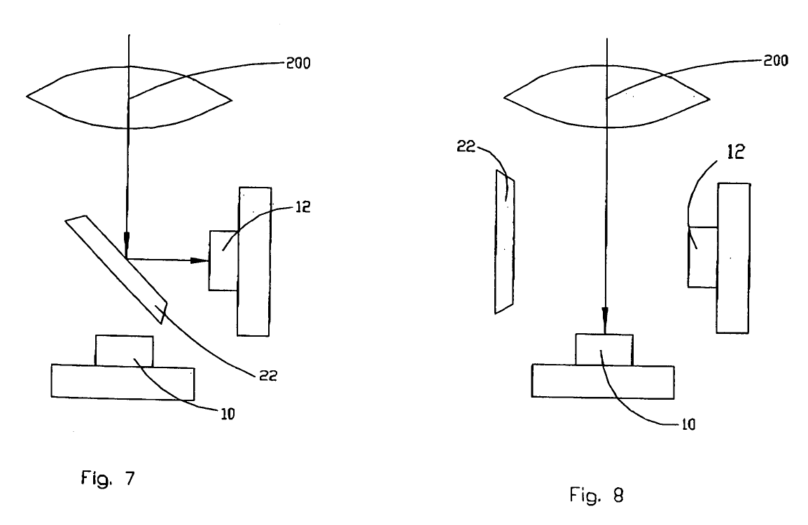

At night or in a dark environment, it is preferable to use the black-and-white sensor because the black-and-white sensor is typically more sensitive than the color sensor. In one embodiment, the second image sensor is a black-and-white sensor. When the optical device 22 is moved to a second position as illustrated in FIG. 7, the optical device 22 reflects the light ray from the lens 200 onto the second image sensor 12. Therefore, the camera may operate as a black-and-white camera in this situation to generate black-and-white images, which are generally sharper than the color images produced by the color sensor.

FIG. 8 illustrates an alternate way to operate the camera. By placing the optical device 22 out of the path of the light ray from the lens 200, the light ray may fall onto the first image sensor 10. As mentioned above, the optical device 22 may include an infrared filter. Since the light ray does not pass through the optical device 22 in FIG. 8, the infrared component of the light ray remains with the light ray when the first image sensor 10 receives the light ray. Hence, the first image sensor 10 can capture an image with infrared effect. In one embodiment, the first image sensor 10 is a color CCD sensor. The configuration in FIG. 8 allows the color CCD sensor to generate unfiltered color images.

In sum, the camera illustrated in FIGS. 6-8 may produce at least three different types of images, namely, black-and-white images, color images with infrared effect, and color images without infrared effect. A user may use the same camera to take pictures under different conditions simply by choosing the appropriate image sensor within the camera to receive light rays.

As discussed above, the optical device (e.g., the optical devices 20, 22, etc.) may be moved to different positions in order to adjust the path of the light ray so that the light ray may be directed to different image sensors within the camera. Alternatively, the optical device may remain stationary, while an electronic controller selects the optical signals from one of the image sensors installed within the camera in order to generate images with different effects. FIG. 9 illustrates such an example.

Referring to FIG. 9, the camera includes a lens 200, an electronic controller 24a, a first and a second image sensors 10 and 12, and an optical device 24. The electronic controller 24a is coupled to both the first and the second image sensors 10 and 12. In one embodiment, the first image sensor 10 is a color CCD sensor and the second image sensor 12 is a black-and-white image sensor. The optical device 24 may be made of semi-transparent material such that the optical device 24 can filter color components of light rays (e.g., infrared), pass a predetermined portion of incoming light rays, and reflect another predetermined portion of incoming light rays at the same time. The first and second image sensors 10 and 12 may include different types of image sensors. For example, the first image sensor 10 may include a color CCD sensor and the second image sensor 12 may include a black-and-white CCD sensor. A predetermined portion of the light ray passes through the optical device 24 and falls onto the first image sensor 10. The first image sensor 10 can output signals of a color image. Furthermore, the optical device 24 reflects another predetermined portion of the light ray to the second image sensor 12 such that the second image sensor 12 can output signals of a black-and-white version of the image.

As mentioned above, the electronic controller 24a can select the signals from either the color CCD sensor 10 or the signals from the black-and-white CCD sensor 12. Since the electronic controller 24a can select the signals from one of the image sensors 10 and 12, it is not necessary to move the optical device 24 to direct the light ray onto a particular image sensor. Consequently, it is less likely to introduce mechanical error that may impact the precision of the camera.

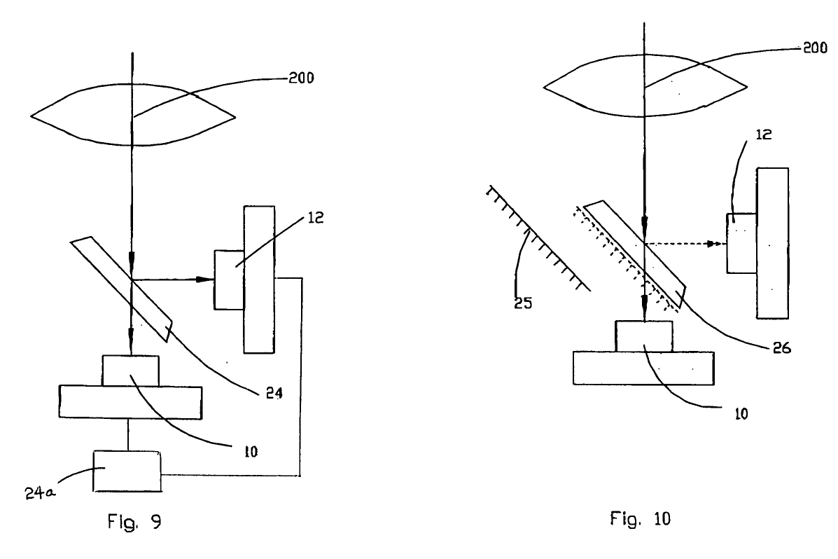

FIG. 10 illustrates another embodiment of a camera according to the present invention. The camera includes a movable opaque panel 25 and a stationary filter 26. In one embodiment, the filter 26 is operable to pass a major portion (e.g., approximately 90%) of the incoming light ray and to reflect a minor portion (e.g., approximately 10%) of the light rays. When taking pictures during daytime or in a well-lit environment, the opaque panel 25 may be moved away from the filter 26 as shown in FIG. 10. Thus, a major portion of the light ray through the lens 200 passes through the filter 26 and falls onto the first image sensor 10 (e.g., a color CCD sensor). The camera operates as a color camera in this situation to output color images.

When taking pictures at night or in a dark environment, the opaque part 25 is moved towards the filter 26 such that the light ray is blocked from the image sensor 10 (as shown by the dotted line in FIG. 10). Since the opaque panel 25 prevents the light ray from passing through the filter 26 to the first image sensor 10, the light ray is, instead, reflected to the image sensor 12 (e.g., a black-and-white CCD sensor). Hence, the camera may operate as a black-and-white camera in this situation to output black-and-white images.

FIG. 11 illustrates an alternate embodiment of the camera. The camera includes a lens 200, a first and a second image sensors 10 and 12, a filter 26, and an opaque panel 25a. The opaque panel 25a may be coupled to the filter 26 at one end as illustrated in FIG. 11 such that the opaque panel 25a may be swung towards or away from the filter 26. To take pictures during daytime or in a well-lit environment, the opaque panel 25a may be swung away from the filter 26 such that the light ray from the lens can pass through the filter 26 to fall onto the first image sensor 10 (e.g., a color CCD sensor). In this situation, the camera may operate as a color camera to output color images. To take pictures at night or in a dark environment, the opaque panel 25a may be swung towards the filter 26 (as shown by the dotted line in FIG. 11) to prevent the light ray from passing through the filter 26 to the first image sensor 10. Instead, the light ray is reflected onto the second image sensor 12 (e.g., a black-and-white CCD sensor). The camera may operate as a black-and-white camera to output black-and-white images in this configuration.

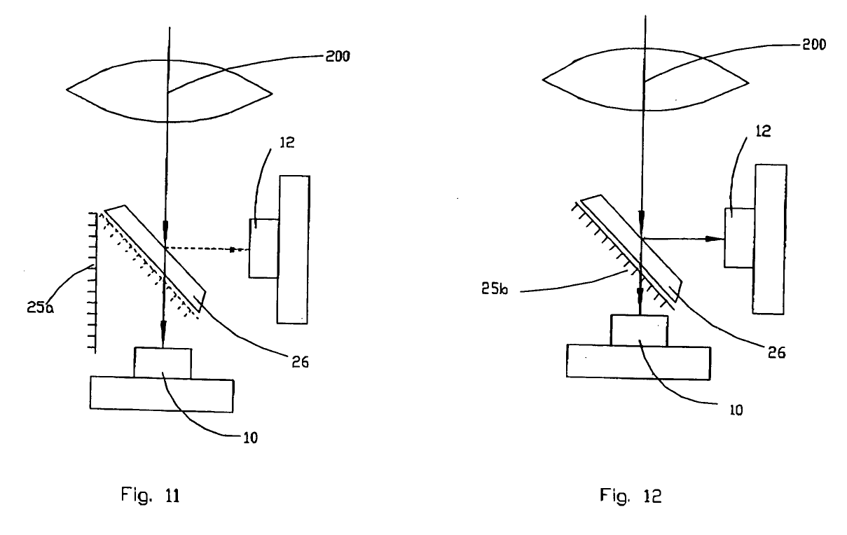

FIG. 12 illustrates an alternate embodiment of the camera. The camera includes a lens 200, a first and a second image sensors 10 and 12, a filter 26, and a liquid crystal display (LCD) panel 25b. The LCD panel 25b may allow light rays to pass through or to block light rays in response to electrical control signals input to the LCD panel 25b. When the LCD panel 25b allows light rays to pass through, the light ray from the lens 200 passes through the filter 26 and then through the LCD panel 25b to the first image sensor 10 (e.g., a color CCD sensor). In this situation, the camera operates as a color camera to output color images. When the LCD panel 25b blocks light rays, the light ray from the lens 200 is blocked off from the first image sensor 10. Hence, only the second image sensor 12 can detect the light ray as the light ray is reflected onto the second image sensor 12. In one embodiment, the second image sensor. 12 is a black-and-white CCD sensor. The camera may, therefore, operate as a black-and-white camera to output black-and-white images in this configuration.

In the embodiments illustrated in FIGS. 10-12, the path of the light ray may be changed or adjusted by moving the opaque panel (e.g., panels 25, 25a, or 25b) without moving the filter 26. By keeping the filter 26 stationary, the precision of the camera may be improved.

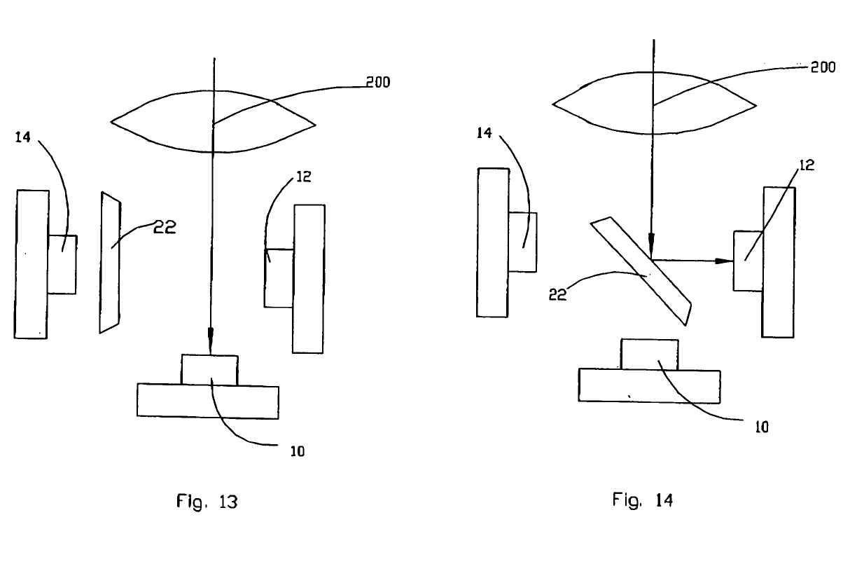

FIGS. 13-16 illustrate one embodiment of the camera. The camera includes a first, a second, and a third image sensors 10, 12, and 14, a lens 200, and a filter 22. The filter 22 can reflect a first predetermined portion of incoming light and refract a second predetermined portion of the incoming light. In one embodiment, the filter 22 is an infrared filter. Referring to FIG. 13, the filter 22 is placed in front of the third image sensor 14 without obstructing the other two image sensors 10 and 12. The light ray through the lens 200 falls directly onto the first image sensor 10 (e.g., a color CCD sensor). In this configuration, the camera may operate as a color camera without infrared filtering.

Under different circumstances, such as different lighting intensities, one may switch to a different image sensor in the camera by adjusting the position or the angle of the filter 22. For example, the filter 22 may be moved to a first predetermined position in between the lens 200 and the first image sensor 10 to reflect the light ray onto the second image sensor 12 as illustrated in FIG. 14. The second image sensor 12 may include a black-and-white CCD sensor. In this situation, the camera operates as a black-and-white camera.

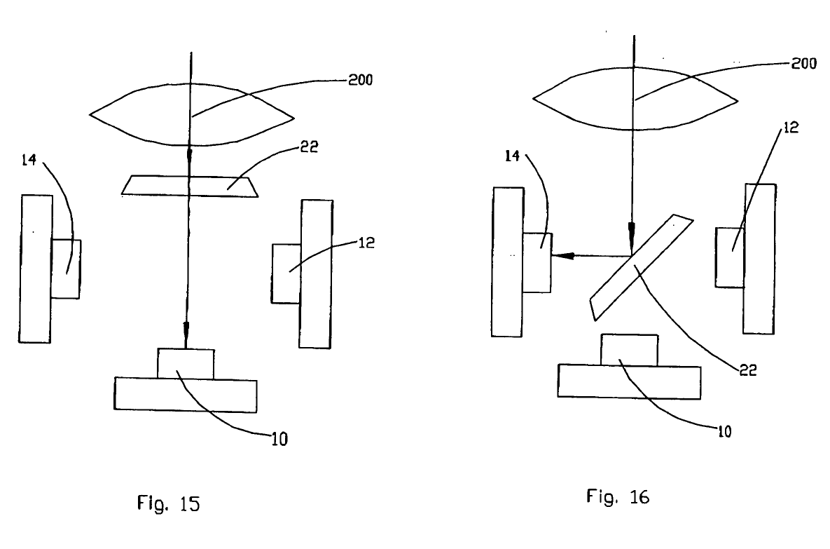

Furthermore, the filter 22 may be moved to a second predetermined position underneath the lens 200 as illustrated in FIG. 15. At this position, the filter 22 filters the light ray to remove the infrared components from the light ray before passing the light ray to the first image sensor 10. In this situation, the camera operates as a color camera with infrared filtering.

Alternatively, the filter 22 may also be moved to a third predetermined position as illustrated in FIG. 16. At this position, the filter 22 reflects the light ray from the lens 200 onto the third image sensor 14. Depending on the characteristics of the third image sensor 14, the camera may operate as a color or a black-and-white camera in this configuration. Therefore, the camera illustrated in FIGS. 14-16 can provide at least four different functions.

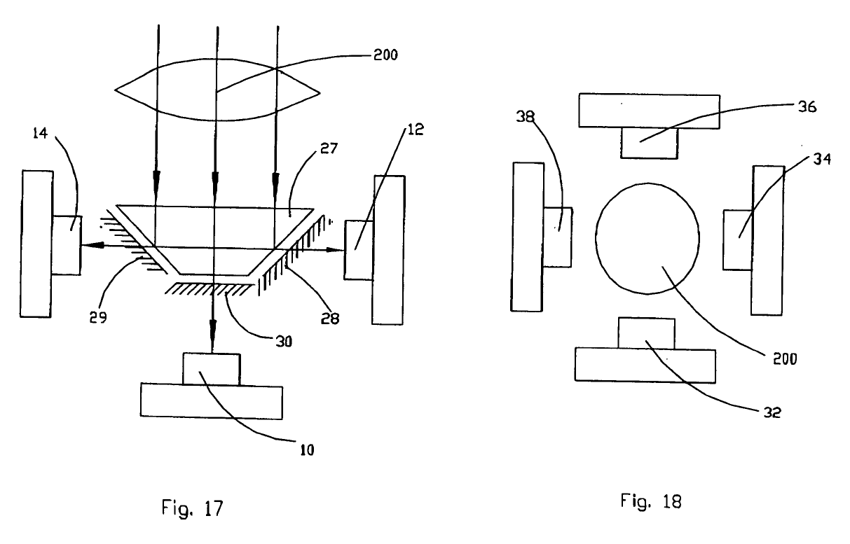

FIG. 17 illustrates an alternate embodiment of the camera. The camera includes a lens 200, a first, a second, and a third image sensors 10, 12, and 14, a prism 27, and three panels 28, 29, and 30. The panels 28-30 may be made of light blocking materials. Alternatively, some or all of the panels 28-30 may be LCD panels. Under different environments or lighting conditions, the panels 28-30 may operate with the prism 27 to direct the light ray from the lens 200 to one of the image sensors 10, 12, or 14 in order to generate a particular type of image.

In one embodiment, the panels 28, 29, and 30 may be moved away from the prism 27 such that the light ray from the lens 200 may pass through the prism 27 to fall onto the first image sensor 10. Alternatively, the panels 29 and 30 may be placed on or near the surfaces of the prism facing the first and third image sensors 10 and 14 to prevent light rays from reaching the first and the third image sensors 10 and 14. Only the second image sensor 12 may receive the light ray reflected by the panel 29. Likewise, the panels 28 and 30 may be placed on or near the surfaces of the prism facing the first and second image sensors 10 and 12 to prevent light rays from reaching the first and the second image sensors 10 and 12 such that only the third image sensor 14 may receive the light ray reflected by the panel 28. The image sensor (one of the image sensors 10, 12, and 14) receiving the light ray from the lens 200 may output signals of the image according to the characteristics of the corresponding image sensor.

Furthermore, one may remove two or more of the panels 28, 29, and 30 from the prism 27 in order to allow more than one of the image sensors 10, 12, and 14 to receive a portion of the light ray from the lens 200. The signals generated by the image sensor(s) that receive the light ray may be used to produce multiple images with different effects.

As mentioned above, the panels 28, 29, and 30 may include one or more LCD panels. The LCD panel may be electronically controlled to block or to pass light. Therefore, making the LCD panel to pass light is functionally substantially equivalent to moving the panel away from the prism 27 in the above example. Likewise, making the LCD panel to block light is functionally substantially equivalent to moving the panel onto or near the corresponding surface of the prism 27 in the above example.

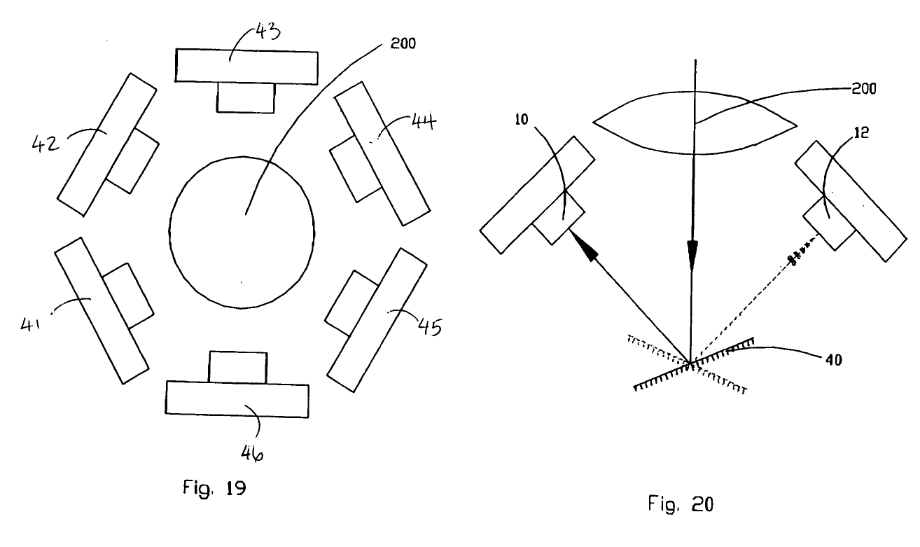

Applying the technique discussed above, some embodiments may include more than three image sensors to enable the camera to produce images having different effects. Furthermore, the image sensors may be parallel to each other or arranged in different configurations. FIGS. 18 and 19 show two examples to illustrate this concept.

Referring to FIG. 18, the camera includes a lens 200, a first, a second, a third, and a fourth image sensors 32, 34, 36, and 38. The image sensors 32-38 are arranged in a square with the lens 200 in the center of the square. FIG. 19 illustrates another embodiment of a camera. The camera includes a lens 200 and six image sensors 41-46 arranged in a circle with the lens 200 in the center of the circle.

FIG. 20 illustrates one embodiment of a camera. The camera includes a lens 200, a first and a second image sensors 10 and 12, and an optical device 40. The optical device 40 is installed across from the lens 200. The first and second image sensors 10 and 12 are mounted on the same side as the lens 200. The optical device 40 may be adjusted by a predetermined angle to reflect the light ray from the lens 200 onto the first image sensor 10 as illustrated in FIG. 20. Likewise, the optical device 40 may be adjusted by another predetermined angle to reflect the light ray from the lens 200 onto the second image sensor 12. The optical device 40 may include a mirror. Alternatively, the optical device 40 may include a prism. Furthermore, other embodiments of the camera may have additional image sensors installed within the camera. The optical device 40 may be moved, such as being rotated by a predetermined angle, to reflect the light ray through the lens 200 onto one of the image sensors, which outputs signals of the image captured. The position and/or the angle of the optical device 40 may be varied in order to direct the light ray onto any one of the image sensors in order to produce images having certain predetermined effects.

In some embodiments, the optical device (e.g., the optical devices 20, 20a, 22, 24, 26, etc.) may be rotated, laterally moved, etc. to direct the light ray through the lens 200 onto a predetermined image sensor in order to produce images having certain predetermined effects.

Furthermore, in some embodiments, the optical device (e.g., the optical devices 20, 20a, 22, 24, 26, etc.) are moved or adjusted using an electronic controller.

In some embodiments, the image sensors (e.g., the image sensors 10, 12, etc.) remain stationary during the operation of the camera while the optical device (e.g., the optical device 20, 20a, 22, etc.) is moved or adjusted to change the paths of the light rays entering the camera through the lens. One advantage of keeping the image sensors stationary is to avoid introducing a mechanical error that may affect the predetermined focus of the camera, and hence, to ensure the images captured are sharp.

Furthermore, electronic circuitry may be used in some embodiments to select the signals from one or more of the image sensors (e.g., CCD sensor, CMOS sensor, etc.) in different applications. By using the electronic circuitry to select the signals, the optical device is not moved. Hence, the mechanical errors introduced by physically moving the optical device within the camera can be avoided. Therefore, the quality of the captured image can be improved.

In one embodiment, the image sensors (e.g., CCD sensors, CMOS sensors) may be moved within the camera in order to receive the light ray through the lens. For example, the image sensors may be moved horizontally, vertically, etc.

In one embodiment, the image sensors may include image sensors having the same characteristics. For example, all the image sensors within one embodiment of the camera may be color CCD sensors. Alternatively, all the image sensors may be black-and-white CCD sensors. Furthermore, all the image sensors may be CMOS sensors in one embodiment. Alternatively, the image sensors in some embodiments may include image sensors of different types having distinct characteristics. For example, one embodiment may include both color and black-and-white sensors. One embodiment may include both CCD and CMOS sensors. Another embodiment may include a color CCD. sensor and a black-and-white CMOS sensor.

By using a single lens with multiple image sensors within the same camera, the camera may provide a wide range of functions for different applications at a low cost. Furthermore, the size of the multi-sensor camera may be reduced because only a single lens is installed in the camera.

The foregoing discussion merely describes some exemplary embodiments of the present invention. One skilled in the art will readily recognize from such discussion, the accompanying drawings and the claims that various modifications can be made without departing from the spirit and scope of the invention.

1. A camera comprising:
a single lens;
a plurality of image sensors, each of the plurality of image sensors having distinct characteristics; and
an optical device positioned between the lens and the plurality of image sensors to direct light rays from the lens to one of the plurality of image sensors.

2. The camera of claim 1, wherein the optical device comprises a body having a plurality of surfaces, at least one of the plurality of surfaces is operable to reflect a predetermined portion of the light rays from the lens to one of the plurality of image sensors.

3. The camera of claim 1, wherein the optical device comprises a body made of a refractive medium to refract a predetermined portion of the light rays from the lens to one of the plurality of image sensors.

4. The camera of claim 1, wherein the optical device comprises a body and a panel, the panel is operable to prevent the light rays from passing through the body while the body remains stationary.

5. The camera of claim 4, wherein the panel comprises a liquid crystal display (LCD) panel.

6. The camera of claim 4, wherein the panel is a movable opaque panel.

7. The camera of claim 1, wherein the optical device reflects a first predetermined portion of the light rays from the lens to a first one of the plurality of image sensors and passes a second predetermined portion of the light rays to a second one of the plurality of image sensors.

8. The camera of claim 1, further comprising a control device to move the optical device in order to direct the light rays to a predetermined one of the plurality of image sensors.

9. The camera of claim 1, further comprising an electronic controller to select signals output by one of the plurality of image sensors.

10. The camera of claim 1, wherein the optical device comprises an infrared filter.

11. The camera of claim 1, wherein the optical device comprises a prism.

12. The camera of claim 1, wherein the plurality of image sensors comprise at least one color image sensor and at least one black-and-white image sensor.

13. The camera of claim 1, wherein the plurality of image sensors comprise at least one complementary metal oxide semiconductor (CMOS) sensor and at least one charge coupled device (CCD) sensor.

14. A method to capture an image using a camera, the method comprising:
receiving light rays through a single lens mounted within the camera; and
adjusting paths of the light rays to direct the light rays to only one of a plurality of image sensors installed within the camera, each of the plurality of image sensors having distinct characteristics.

15. The method of claim 14, wherein adjusting the paths of the light rays includes moving an optical device to a predetermined position corresponding to the one image sensor.

16. The method of claim 14, wherein adjusting the paths of the light rays further includes reflecting the light rays by the optical device onto the one image sensor.

17. The method of claim 14, wherein adjusting the paths of the light rays further includes refracting the light rays using the optical device such that the light rays are directed onto the one image sensor through the optical device.

18. The method of claim 14, further comprising filtering the light rays to remove a predetermined component of the light rays.

19. The method of claim 18, wherein filtering the light rays comprises removing an infrared component from the light rays.

20. The method of claim 14, further comprising selecting image signals from one of the plurality of image sensors.

21. A camera comprising:
means for receiving light rays through a single lens mounted within the camera; and
means for adjusting paths of the light rays to direct the light rays to one of a plurality of image sensors installed within the camera, each of the plurality of image sensors having distinct characteristics.

22. The camera of claim 21, wherein the means for adjusting paths of the light rays includes:
means for selecting image signals from one of the plurality of image sensors.
